(19) United States
(12) Patent Application Publication
(10) Pub. No.: US 2019/0208580 A1
(43) Pub. Date: Jul. 4, 2019

(54) Systems and Methods for Heating

(71) Applicant: The Endeavour Group, Inc., West Jordan, UT (US)

(72) Inventors: Andrew Conner, West Jordan, UT (US); John R. Conner, Holladay, UT (US)

(21) Appl. No.: 16/231,041

(22) Filed: Dec. 21, 2018

Related U.S. Application Data
(60) Provisional application No. 62/612,258, filed on Dec. 29, 2017.

(51) Int. Cl. H05B 3/34; H05B 1/02

(52) U.S. Cl. CPC H05B 3/342; H05B 1/0294

(57) ABSTRACT

Heating systems, methods for manufacturing heating systems, and methods for using heating systems are provided. A heating system includes a nano-layer a first polymer layer contacting and extending along a first side of the nano-layer, and a second polymer layer contacting and extending along a second side of the nano-layer. The seat heater also includes lead wires connected between the nano-layer and a heater control system operatively connected to a power supply. The control system may be controlled using an application programming interface running on a mobile electronic device. The nano-layer, the first polymer layer, and the second polymer layer form a flexible sheet that is attached to or incorporated in an item to be heated.

### CROSS-REFERENCE TO RELATED APPLICATIONS

This application is claims priority to United States Provisional Patent Application No. 62/612,258 filed on Dec. 29, 2017.

### BACKGROUND OF THE INVENTION

### 1. Field of the Invention

The present invention relates to electronic heating devices, and more particularly to an electronic heater for various uses.

### 2. Background and Related Art

Heating devices are commonly provided in tents, clothing, food carriers, vehicles, medical devices and other small equipment needing heat, and the like. Some heating devices are chemical, others use residual heat stored in a thermal mass, while other heating devices burn a fuel to create heat. Still other heating devices use electric energy provided by a battery or a connection to a power supply (e.g., a grid-connected power supply, a power supply connected to a solar power source, a power supply connected to an electric generator, and the like).

Chemical heaters are limited in the manners in which they can be used. Such heaters have limited mechanisms to control the temperature of the heater. Additionally, chemical heaters are typically limited in the length of time in which heat can be provided before the chemical reaction that provides the heat terminates due to a lack of reagents. While chemical heaters can be manufactured in a variety of sizes and are generally fairly flexible in how they can be conformed to fit within a certain space, the requirement of having chemical reagents to generate heat limits the ways in which chemical heaters can be used, and the chemical reagents may take up significant volume in locations where volume may be limited. Chemical heaters can be difficult to control the amount of heat output. Accordingly, the chemical heaters are limited in their use.

Thermal mass heaters have similar benefits and limitations to chemical heaters. They also have an additional limitation in that the temperature of the thermal mass steadily decreases throughout the period of its use. While thermal mass heaters can have a controlled starting temperature, it can be difficult to control the rate at which heat is lost and at which the temperature drops accordingly. Accordingly, the situations in which thermal mass heaters are of significant benefit are limited.

Heating devices that burn a fuel are also limited in the methods in which they can be used. Fuel-burning heating devices often pose a fire hazard in use or with respect to stored fuel. Additionally, many fuel-burning heating devices generate carbon monoxide and are thus ill suited for use in enclosed spaces. Many fuel-burning heating devices further generate heat that is too hot for many desired applications, risking burns to the user, as well as potentially being damaging for items or equipment surrounding the heating device. It can be difficult to control the heat output of fuel-burning heating devices. In some instances, fuel is burned at least somewhat remotely from the location where heat is desired, and heat is then transferred to the location where heat is desired. An example of this is a typical automobile in which fuel is burned in the engine, heat from the engine is transferred to an antifreeze mixture, which is circulated to a heat exchanger in the passenger compartment. Such heat transfer systems are sufficiently complex to limit their use in many instances.

For reasons such as these, electric heating devices are commonly used in situations where controlled heat is desired for periods of time longer than can be reliably provided using chemical or thermal mass heating devices, or where burning fuel would be unsafe or would provide too much heat. For example, electric heating devices are commonly used in automobile seats, room heaters, heaters for small vehicles, and the like. Electric heating devices typically require some sort of electrical power supply, but it is common for a variety of electrical power sources to be available, such as a grid-connected supply, a battery supply, a solar power supply, or a generator supplying power may be used.

Even where power is generally available, existing electric heating devices have certain limitations. Electric heating devices commonly include a heating element or wire that heats up as electric current passes through it. Other heating devices use a simple incandescent bulb, in which the heating element or wire is contained within an evacuated glass structure. Regardless, the heating element or wire can be subject to breakage, which often causes partial or complete failure of the electric heating device. This can be particularly problematic in situations where the heating element or wire is subject to deformation, at least somewhat limiting the use of electric heating devices in environments where deformation is to be expected, or requiring protection of electric heating devices within a rigid protective structure, which may limit the electric heating device's uses.

Additionally, because heating of the electric heating devices is localized at the heating element or wire, the distribution of heat is often uneven. In some instances, the uneven distribution of heat may cause localized hot spots that may constitute a fire hazard or a contact burn risk. Uneven heating may also result in a situation where portions of a device or area to be heated are overheated while other portions of a device or area to be heated are under-heated. Finally, it can be difficult to precisely control electric heating devices in part because of the inherent unevenness of such devices. Accordingly, the use of existing electric heating devices is limited and subject to ongoing difficulties.

### BRIEF SUMMARY OF THE INVENTION

Implementation of the invention provides novel heating systems, methods for manufacturing heating systems, and methods for using heating systems. According to an exemplary implementation of the invention, a heating system includes a layer with an electrothermal coating which has nanostructures mixed and dispersed in a polymer matrix and having more than one type of low-dimensional nanostructure. Such nanostructures may include a combination of nanospheroids combined with linear nanostructures and or planar nanostructures. It is preferred that the concentration of mixed nanostructures is within the cured polymer composite coating below the percolation limit of each individual carbon nanostructure type, alone, within an identical polymer matrix. This layer will hereinafter be referred to as the “nano-layer”.

As used herein with respect to nanostructure concentration “percolation limit concentration” refers to the volume fraction of nanostructures within the polymer below which the electrical conductivity of the composite falls to a value with about 5% of the electrical conductivity of the polymer alone. The behavior of conductivity with respect to volume fraction is analyzed by percolation theory, which includes multiple types. Two known examples are statistical homogeneously structured and randomly distributed filler particles fixed in the matrix from percolating paths. Statistical percolation theory generally follows the relation: [symbol] = [symbol] ₒ (Φ−Φ_{c})^{t}, where a represents electrical conductivity, Φ represents volume fraction filler, Φ represents the volume fraction that is the percolation limit concentration and t is expected to range typically from about 1.3 to about 4 and is dependent on the dimensionality of the filler (0D, 1D, 2D, 3D etc.). This relation can be representative of experimental data as it does not consider aspect ratio of 1D systems. For composites filled with carbon nanotubes, an ID nanostructure with an aspect of [symbol] =L/W, statistical

$${φ}_{c} ∼ \frac{1}{2 η} .$$

A relation derived from the concept of excluded volume. With respect to the present invention, the percolation limit concentration of a low dimensional carbon nanostructure-polymer composite can be reduced to below the statistical percolation limit by preparing the nanostructure filler as a random mixture of 0D with any one or more 1D and 2D nanostructures. A first polymer layer contacting and extending along a first side of the nano-layer, a second polymer layer contacting and extending along a second side of the nano-layer, and lead wires connected between the nano-layer and a heater control system operatively connected to a power supply. The nano-layer, the first polymer layer, and the second polymer layer form a flexible sheet.

A “nanostructure” refers to material sizes which enable the material to exhibit properties within at least one dimension that are intermediate between the property of a single atom or molecule and that of the corresponding bulk material. Further, nanostructures can have a smallest physical dimension (e.g. width, length thickness, diameter, etc.) which is less than about 900 nm, and in some cases can be less than about 100 nm. The properties of particular interest herein are electrical conductivity, electrical percolation limits, and thermal conductivity. For example, in the case of a carbon nanotube, a 1D nanostructure, the nanotube acts as a quantum waveguide limiting conductivity to one dimension, along the tube. This results in a value for conductivity in that dimension far exceeding the conductivity of a bulk-material of the same element, such as graphite. In the case of graphene, a 2D nanostructure, the conductivity is limited to two dimensions, forming a conductive plane. In the context of nanostructure polymer composite, a 0D nanostructure can function as a conductive island within the polymer matrix which can facilitate tunneling of charges between nearest neighboring nanostructures within the polymer matrix. Conduction can be achieved when a 1D or 2D structure makes contact to multiple 0D nanostructures, acting as a conductive bridge.

The flexible sheet may be affixed to or incorporated in an item such as a building roof, a wall of a tent, a ceiling or roof of a tent, a floor of a tent, an anesthetic carpule or cartridge warmer and dispenser, a vehicle or golf cart cover, a vehicle or golf cart seat cover, a pizza box warmer, an item of clothing, or an item of compression clothing.

The nano-layer may have a thickness of approximately 0.01 mil. The first polymer layer and the second polymer layer may have a thickness of between approximately 5 mil and approximately 20 mil. The first polymer layer and the second polymer layer may include a material such as polyethylene terephthalate (PET), biaxially oriented polyethylene terephthalate (BoPET), or polycyclohexylenedimethylene terephthalate (PCT).

According to certain implementations, the nano-layer does not contain electrically conductive metal wires extending along the sheet except the lead wires proximate an edge of the sheet. The heater control system may include a variable output having at least eight available output powers. The heater control system may have a wireless communication link to permit control of the heating system by an application programming interface (API) operating on a mobile computing device. The mobile computing device may be a device such as a smartphone, a tablet, a laptop computer or a dedicated heating system control device.

According to further implementations of the invention, a method for manufacturing a heating system for an item to be heated includes steps of providing a first polymer layer, spreading a nanostructure-containing mixture on the first polymer layer to form an electrothermal layer on the first polymer layer, placing a second polymer layer on the electrothermal layer to form a flexible sheet having the electrothermal layer sandwiched between the first and second polymer layers, cutting the flexible sheet to a shape adapted to provide heat to a desired area of an item to be heated, affixing electrical leads to different areas of the electrothermal layer, and affixing the flexible sheet to or incorporating the flexible sheet in a desired location of the item to be heated.

The flexible sheet may be affixed to or incorporated in an item such as a wall of a tent, a ceiling or roof of a tent, a floor of a tent, an anesthetic carpule or cartridge warmer and dispenser, a vehicle or golf cart cover, a vehicle or golf cart seat cover, a pizza box warmer, an item of clothing, an item of compression clothing, or under concrete in a driveway.

In the method, the electrothermal layer may have a thickness of approximately 0.01 mil. In the method, the first polymer layer and the second polymer layer may include a material such as PET, BoPET, or PCT. In the method the flexible sheet may be affixed to the item to be heated by a method such as gluing, bonding, or stitching.

The method may further include operatively attaching the electrical leads to a heater control system.

The flexible sheet may be cut into a first flexible sheet placed at a first desired area of the item to be heated and a second flexible sheet placed at a second desired area of the item to be heated.

According to still further implementations of the invention, a heating system includes a nano-layer, a first polymer layer contacting and extending along a first side of the nano-layer, a second polymer layer contacting and extending along a second side of the nano-layer, and lead wires connected between the nano-layer and a heater control system operatively connected to a power supply, the heater control system comprising a wireless communication link to permit control of the heating system by an application programming interface (API) operating on a mobile computing device. The nana-layer, the first polymer layer, and the second polymer layer form a flexible sheet that is attached to or incorporated in an item to be heated.

The flexible sheet may be affixed to or incorporated in an item such as a building roof, a wall of a tent, a ceiling or roof of a tent, a floor of a tent, an anesthetic carpule or cartridge warmer and dispenser, a vehicle or golf cart cover, a vehicle or golf cart seat cover, a pizza box warmer, an item of clothing, or an item of compression clothing.

The nano-layer may have a thickness of approximately 0.01 mil. The first polymer layer and the second polymer layer may have a thickness of between approximately 5 mil and approximately 20 mil. The first polymer layer and the second polymer layer may include a material such as PET, BoPET, or PCT.

According to certain implementations, the nano-layer does not contain electrically conductive metal wires extending along the sheet except the lead wires proximate an edge of the sheet. The heater control system may include a variable output having at least eight available output powers. The heater control system may have a wireless communication link to permit control of the heating system by an application programming interface (API) operating on a mobile computing device. The mobile computing device may be a device such as a smartphone, a tablet, a laptop computer or a dedicated heating system control device.

### BRIEF DESCRIPTION OF THE SEVERAL VIEWS OF THE DRAWINGS

The objects and features of the present invention will become more fully apparent from the following description and appended claims, taken in conjunction with the accompanying drawings. Understanding that these drawings depict only typical embodiments of the invention and are, therefore, not to be considered limiting of its scope, the invention will be described and explained with additional specificity and detail through the use of the accompanying drawings in which:

FIG. 1 shows an illustrative vehicle seat in which a seat heater may be incorporated;

FIG. 2 shows an illustrative cross-sectional view of a portion of a flexible heating sheet in accordance with certain embodiments of the invention;

FIG. 3 shows an illustrative top view of a flexible heating sheet in accordance with certain embodiments of the invention;

FIG. 4 shows an illustrative computing device that may be used in conjunction with embodiments of the invention;

FIG. 5 shows an illustrative carpule or cartridge dispenser and warmer;

FIG. 6 shows an illustrative pizza warmer;

FIG. 7 shows an illustrative golf cart cover;

FIG. 8 shows an illustrative compression shirt; and

FIG. 9 shows an illustrative tent.

### DETAILED DESCRIPTION OF THE INVENTION

A description of embodiments of the present invention will now be given with reference to the Figures. It is expected that the present invention may take many other forms and shapes, hence the following disclosure is intended to be illustrative and not limiting, and the scope of the invention should be determined by reference to the appended claims.

Embodiments of the invention provide novel heating systems, methods for manufacturing heating systems, and methods for using heating systems. According to an exemplary embodiment of the invention, a heating system includes a nano-layer, a first polymer layer contacting and extending along a first side of the nano-layer, a second polymer layer contacting and extending along a second side of the nano-layer, and lead wires connected between the nano-layer and a heater control system operatively connected to a power supply. The nano-layer, the first polymer layer, and the second polymer layer form a flexible sheet.

The flexible sheet may be affixed to or incorporated in an item such as a wall of a tent, a ceiling or roof of a tent, a floor of a tent, an anesthetic carpule or cartridge warmer and dispenser, a vehicle or golf cart cover, a vehicle or golf cart seat cover, a pizza box warmer, an item of clothing, or an item of compression clothing.

The nano-layer may have a thickness of approximately 0.01 mil. The first polymer layer and the second polymer layer may have a thickness of between approximately 5 mil and approximately 20 mil. The first polymer layer and the second polymer layer may include a material such as polyethylene terephthalate (PET), biaxially oriented polyethylene terephthalate (BoPET), or polycyclohexylenedimethylene terephthalate (PCT).

According to certain embodiments, nano-layer does not contain electrically conductive metal wires extending along the sheet except the lead wires proximate an edge of the sheet. The heater control system may include a variable output having at least eight available output powers. The heater control system may have a wireless communication link to permit control of the heating system by an application programming interface (API) operating on a mobile computing device. The mobile computing device may be a device such as a smartphone, a tablet, a laptop computer or a dedicated heating system control device.

According to further embodiments of the invention, a method for manufacturing a heating system for an item to be heated includes steps of providing a first polymer layer, spreading a graphene-containing mixture on the first polymer layer to form an electrothermal layer on the first polymer layer, placing a second polymer layer on the electrothermal layer to form a flexible sheet having the electrothermal layer sandwiched between the first and second polymer layers, cutting the flexible sheet to a shape adapted to provide heat to a desired area of an item to be heated, affixing electrical leads to different areas of the electrothermal layer, and affixing the flexible sheet to or incorporating the flexible sheet in a desired location of the item to be heated.

The flexible sheet may be affixed to or incorporated in an item such as a wall of a tent, a ceiling or roof of a tent, a floor of a tent, an anesthetic carpule or cartridge warmer and dispenser, a vehicle or golf cart cover, a vehicle or golf cart seat cover, a pizza box warmer, an item of clothing, or an item of compression clothing.

In the method, the electrothermal layer may have a thickness of approximately 0.01 mil. In the method, the first polymer layer and the second polymer layer may include a material such as PET, BoPET, or PCT. In the method the flexible sheet may be affixed to the item to be heated by a method such as gluing, bonding, or stitching.

The method may further include operatively attaching the electrical leads to a heater control system.

The flexible sheet may be cut into a first flexible sheet placed at a first desired area of the item to be heated and a second flexible sheet placed at a second desired area of the item to be heated.

According to still further embodiments of the invention, a heating system includes a nano-layer, a first polymer layer contacting and extending along a first side of the nano-layer, a second polymer layer contacting and extending along a second side of the nano-ayer, and lead wires connected between the nano-layer and a heater control system operatively connected to a power supply, the heater control system comprising a wireless communication link to permit control of the heating system by an application programming interface (API) operating on a mobile computing device. The nano-layer, the first polymer layer, and the second polymer layer form a flexible sheet that is attached to or incorporated in an item to be heated.

The flexible sheet may be affixed to or incorporated in an item such as a wall of a tent, a ceiling or roof of a tent, a floor of a tent, an anesthetic carpule or cartridge warmer and dispenser, a vehicle or golf cart cover, a vehicle or golf cart seat cover, a pizza box warmer, an item of clothing, or an item of compression clothing.

The nano-layer may have a thickness of approximately 0.01 mil. The first polymer layer and the second polymer layer may have a thickness of between approximately 5 mil and approximately 20 mil. The first polymer layer and the second polymer layer may include a material such as PET, BoPET, or PCT.

According to certain embodiments, the nano-layer does not contain electrically conductive metal wires extending along the sheet except the lead wires proximate an edge of the sheet. The heater control system may include a variable output having at least eight available output powers. The heater control system may have a wireless communication link to permit control of the heating system by an application programming interface (API) operating on a mobile computing device. The mobile computing device may be a device such as a smartphone, a tablet, a laptop computer or a dedicated heating system control device.

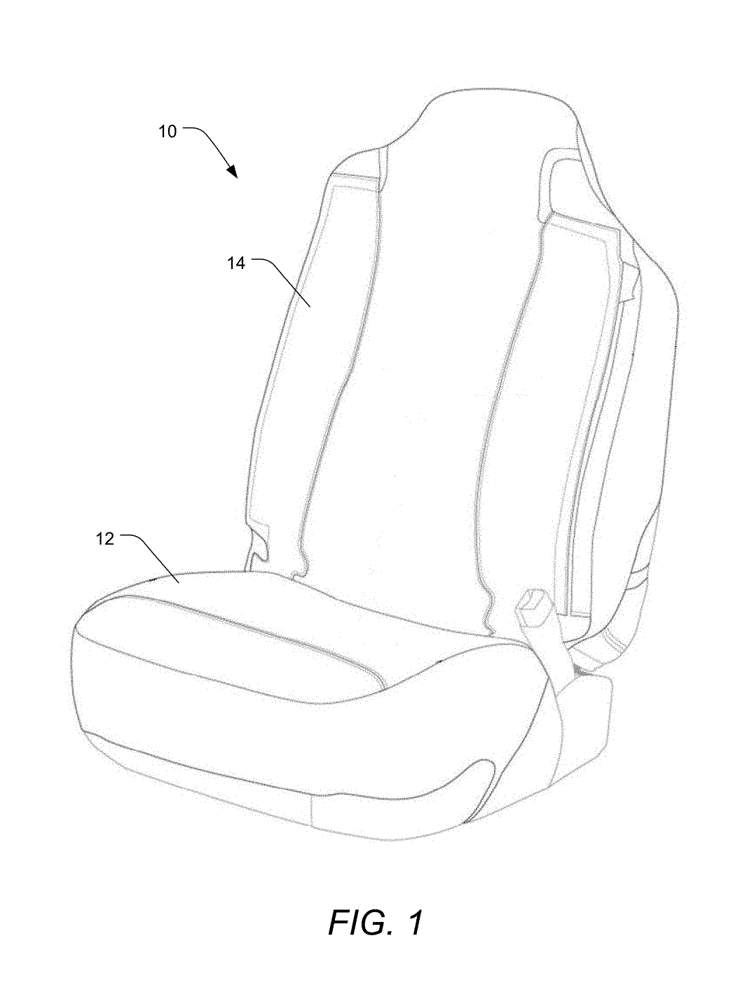

FIG. 1 shows an illustrative vehicle seat 10 that may incorporate a cover having a heating system in accordance with embodiments of the invention. The seat 10 typically includes a seat portion 12 and a back portion 14. As is known in the art, the seat portion 12 may be viewed as being generally horizontal, although the seat portion 12 may be contoured and angled away from a strict horizontal orientation for comfort and convenience of the occupant. The seat 10 also includes a back portion 14, which may be viewed as being generally vertical, although the back portion 14 may also be contoured and angled away from a strict vertical orientation for comfort and convenience of the occupant. The exact position and angle of the seat portion 12 and the back portion 14 may be adjustable to maximize comfort and convenience for occupants of different body types, sizes, and weights.

As is known in the art, the seat 10 generally includes an underlying support structure (not shown in FIG. 1) that is typically formed of metal and provides sufficient support to support an occupant in typical use, as well as in the case of short-term large forces such as might be encountered in a vehicular collision. To improve comfort of the occupant, the underlying support structure is generally covered by layers of materials such as springs, foam, and an outer covering such as of cloth, leather, and/or vinyl or other synthetic material. The outer covering also serves to improve the appearance of the seat 10, and may include decorative features such as contrasting materials or colors, stitching, and the like.

Incorporating one or more heating systems into a cover for the seat 10 may improve the comfort of the occupant, especially during cold periods of time, and especially before the engine of the vehicle has had sufficient time to warm up to a point where engine warmth may be used to warm the vehicle's occupants. In general, it is advantageous to provide seat heating at least on those portions of the seat 10 that are anticipated to be in contact with the occupant's body. Accordingly, embodiments of the invention embrace the provision of seat heating to at least an upper surface of the seat portion 12, and/or to at least a forward surface of the back portion 14. While traditional seat heaters only provided heating to limited portions of the upper surface of the seat portion 12 and/or to the forward surface of the back portion, in part to avoid issues of premature failure discussed in the background, embodiments of the invention permit heating to be delivered to as much of the upper surface of the seat portion 12 and/or to as much of the forward surface of the back portion 14 as may be desired, using a seat cover.

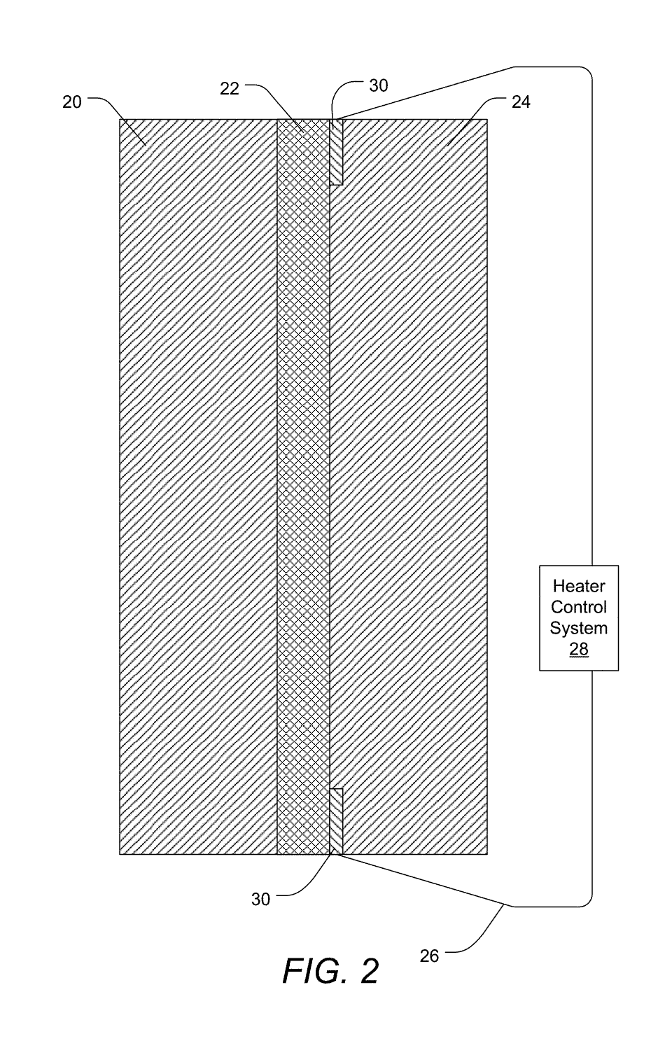

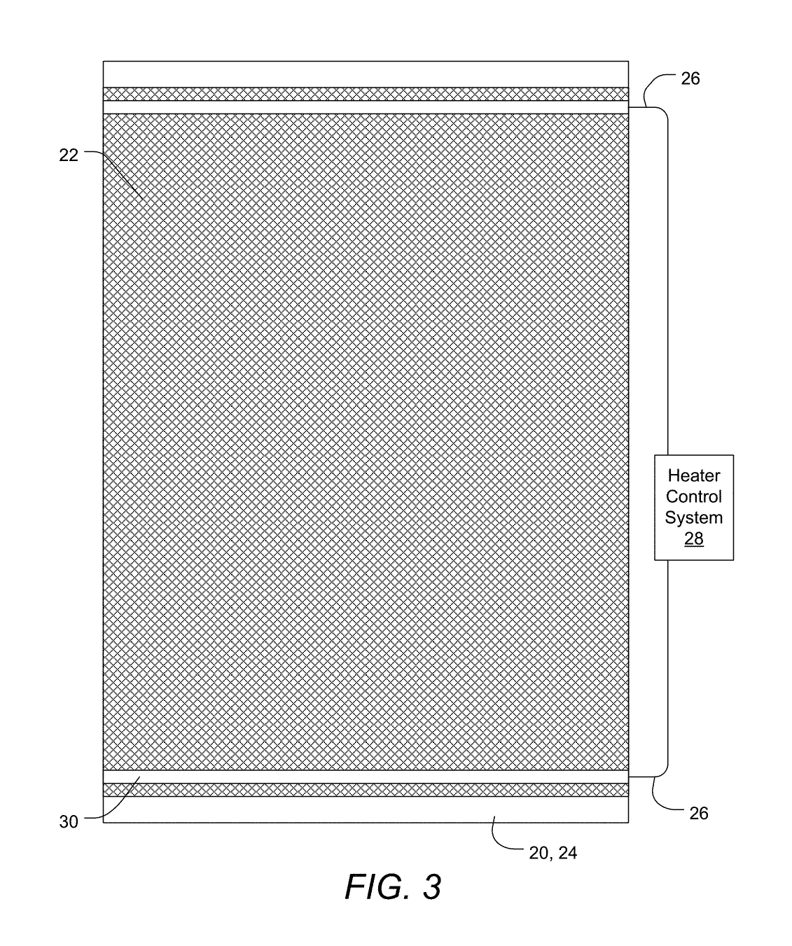

This may be achieved because of the flexible seat heater sheet structure illustrated in FIGS. 2 and 3. FIG. 2 illustrates a representative cross-sectional view (not shown to scale) of a portion of just one embodiment of a flexible seat heater sheet structure, and FIG. 3 shows a top view of one embodiment of a flexible seat heater sheet structure. The structure illustrated in FIG. 2 includes a first polymer layer 20, a nano-layer 22, and a second polymer layer 24. Each of these layers is generally flexible in nature, allowing the seat heater sheet structure to be conformed to any contours of the seat 10 in which the sheet structure is incorporated, and also for the sheet structure to deform and flex as the seat occupant enters the seat 10, exits the seat 10, and/or moves around within the seat 10.

While FIG. 2 illustrates the first polymer layer 20 and the second polymer layer 24 as being of equal thickness, the first polymer layer 20 and the second polymer layer 24 may be of different thicknesses. Each of the first polymer layer 20 and the second polymer layer 22 may be formed of or include a variety of polymer materials such as PET, BoPET, or PCT. The first polymer layer 20 and/or the second polymer layer 22 may have a thickness similar to the thickness of the electrothermal layer 22, or may have a thickness greater than the thickness of the electrothermal layer 22, up to any desired thickness maintaining desired strength and flexibility characteristics. The nano-layer 22 may be formed of the material known as Nanoxene, developed by Mr. Feng Liu of the University of Utah and now being marketed and/or further developed by Life-E, LLC of Sandy, Utah. This material is affordable, lightweight, and adaptable. It is made up of a proprietary advanced multicomponent nanocomposite material including graphene therein. Graphene is an advanced material that is versatile, strong, and an excellent conductor of heat and electricity.

One advantage of forming the electrothermal layer 22 of a graphene-containing material such as Nanoxene is that the heat output of the electrothermal layer 22 is readily tunable by varying the amount of energy supplied to the seat heater. Accordingly, a controller connected to the flexible sheet can be readily adapted to provide a variety of output levels, and the amount of heat generated can be tuned to a comfortable level without overheating the seat occupant. Additionally, because the entire electrothermal layer 22 is conductive, the flexible sheet is resistant to loss of functionality due to localized discontinuities within the electrothermal layer 22. If a localized discontinuity occurs, energy is simply conducted around the discontinuity, and the seat heater continues to function essentially as normal. The bulk conductivity of the Nanoxene material may be made several orders of magnitude higher than most conventional conducting films, with high conversion efficiency of electricity to heat.

Another advantage of the Nanoxene material's conductivity is that the material may be cut to fit or conform to any desired shape. By way of example, the flexible sheet having the electrothermal layer 22 may be cut to generally or closely match the shape of the upper surface of the seat portion 12 or to generally or closely match the shape of the front surface of the back portion 14, such that heat is distributed evenly to essentially the whole top surface of the seat portion 12 and/or to essentially the whole front surface of the back portion 14. After the flexible sheet is cut to size and shape, lead wires 26 may be operatively attached to the electrothermal layer 22 proximate opposing edges of the flexible sheet, and the lead wires 26 may be operatively attached to a heater control system 28 which provides controlled amounts of power to the flexible sheet. By way of example, the lead wires 26 may be attached to metal (e.g. copper) traces 30 disposed on and in contact with opposite edges of the electrothermal layer 22.

The heater control system 28 may provide any desired amount of flexibility in controlling the amount of heat output by the seat heater. By way of example, the heater control system 28 may be configured to have one, two, three, four, five, six, seven, eight, nine, ten, or more output levels, and may be configured to have a continuously variable output within its output range. The heater control system 28 may be operated or controlled using a wired or wireless connection to an in-vehicle control panel, or it may be operated via an API running on a mobile computing device.

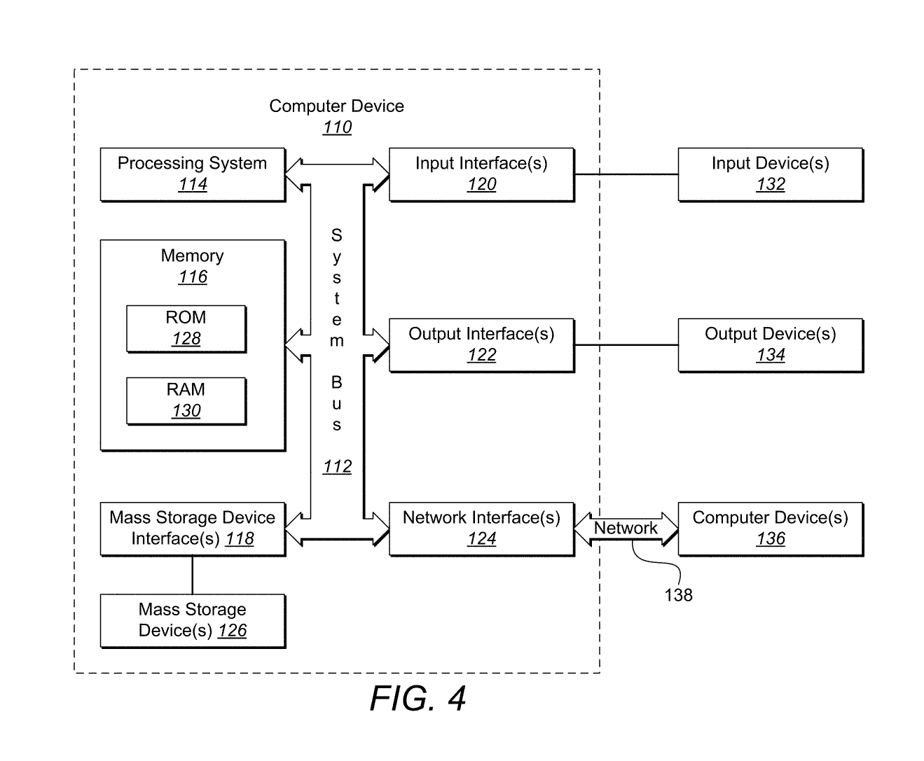

As embodiments of the invention may utilize an API operating on a mobile computing device, FIG. 4 and the corresponding discussion are intended to provide a general description of a suitable operating environment in which certain embodiments of the API may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer, embodiments of the present invention include utilization of the methods and processes in a variety of environments, including embedded systems with general purpose processing units, digital/media signal processors (DSP/MSP), application specific integrated circuits (ASIC), stand alone electronic devices, and other such electronic environments.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

With reference to FIG. 4, a representative system for implementing embodiments of the invention includes computer device 110, which may be a general-purpose or special-purpose computer or any of a variety of consumer electronic devices. For example, computer device 110 may be a notebook or laptop computer, a netbook, a personal digital assistant (“PDA”) or other hand-held device, a smart phone, a tablet computer, a processor-based consumer electronic device, a computer device integrated into another device or vehicle, or the like.

Computer device 110 includes system bus 112, which may be configured to connect various components thereof and enables data to be exchanged between two or more components. System bus 112 may include one of a variety of bus structures including a memory bus or memory controller, a peripheral bus, or a local bus that uses any of a variety of bus architectures. Typical components connected by system bus 112 include processing system 114 and memory 116. Other components may include one or more mass storage device interfaces 118, input interfaces 120, output interfaces 122, and/or network interfaces 124, each of which will be discussed below.

Processing system 114 includes one or more processors, such as a central processor and optionally one or more other processors designed to perform a particular function or task. It is typically processing system 114 that executes the instructions provided on computer-readable media, such as on memory 116, a magnetic hard disk, a removable magnetic disk, a magnetic cassette, an optical disk, or from a communication connection, which may also be viewed as a computer-readable medium.

Memory 116 includes one or more computer-readable media that may be configured to include or includes thereon data or instructions for manipulating data, and may be accessed by processing system 114 through system bus 112. Memory 116 may include, for example, ROM 128, used to permanently store information, and/or RAM 130, used to temporarily store information. ROM 128 may include a basic input/output system (“BIOS”) having one or more routines that are used to establish communication, such as during start-up of computer device 110. RAM 130 may include one or more program modules, such as one or more operating systems, application programs, and/or program data.

One or more mass storage device interfaces 118 may be used to connect one or more mass storage devices 126 to system bus 112. The mass storage devices 126 may be incorporated into or may be peripheral to computer device 110 and allow computer device 110 to retain large amounts of data. Optionally, one or more of the mass storage devices 126 may be removable from computer device 110. Examples of mass storage devices include hard disk drives, magnetic disk drives, solid state drives, tape drives and optical disk drives. A mass storage device 126 may read from and/or write to a magnetic hard disk, a removable magnetic disk, a magnetic cassette, an optical disk, or another computer-readable medium. Mass storage devices 126 and their corresponding computer-readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 120 may be employed to enable a user to enter data and/or instructions to computer device 110 through one or more corresponding input devices 132. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 120 that may be used to connect the input devices 132 to the system bus 112 include a serial port, a parallel port, a game port, a universal serial bus (“USB”), an integrated circuit, a firewire (IEEE 1394), or another interface. For example, in some embodiments input interface 120 includes an application specific integrated circuit (ASIC) that is designed for a particular application. In a further embodiment, the ASIC is embedded and connects existing circuit building blocks.

One or more output interfaces 122 may be employed to connect one or more corresponding output devices 134 to system bus 112. Examples of output devices include a monitor or display screen, a speaker, and the like. A particular output device 134 may be integrated with or peripheral to computer device 110. Examples of output interfaces include a video adapter, an audio adapter, a parallel port, and the like.

One or more network interfaces 124, which may be a wireless network interface, enable computer device 110 to exchange information with one or more other local or remote computer devices or heater controllers, illustrated as computer devices 136, via a connection such as network 138 (which may be a two-device wireless network) that may include hardwired and/or wireless links. The network interface 124 may be incorporated with or peripheral to computer device 110. In a networked system, accessible program modules or portions thereof may be stored in a remote memory storage device.

To construct the seat cover heating system, the first polymer layer 20 may first be provided, and then Nanoxene material may be painted or spread on the first polymer layer so as to form the electrothermal layer 22. Then, the second polymer layer 24 may be disposed on the electrothermal layer 22, thereby creating a flexible sheet of sandwiched layers as illustrated in FIG. 2. The flexible sheet may be made of any desirable size, but will generally be at least slightly larger than the desired area to be heated. The flexible sheet may then be cut to size, and lead wires are attached to the properly sized sheet, with the lead wires making electrical contact with the electrothermal layer 22 on opposing sides of the sheet. Alternatively, the flexible sheet may be formed to the desired size and/or shape at the time of forming the flexible sheet without later cutting the flexible sheet to size. In some instances, the lead wires may be attached to the electrothermal layer 22 prior to disposing the second polymer layer 24 over the electrothermal layer 22.

The properly sized flexible sheet is then disposed within the seat cover (e.g. under the outer cover of the seat portion 12 and/or the back portion 14), and may optionally be bonded, glued, stitched to, or otherwise attached to either the inside of the seat cover. The seat cover may then be disposed on the seat 10 as generally occurs with respect to non-heating seat covers. The lead wires are operatively attached to the heater control system 28, and the seat heater can then be controlled by either physical controls within the vehicle or using the API as discussed above.

The flexibility of the flexible sheet and the even and controlled heating of the flexible sheet allows it to be used in a variety of other items. For example, traditional anesthetic carpule or cartridge heaters and dispensers typically use a lightbulb or other point heating element in an attempt to gently warm the injectable liquid to a temperature that will not deliver a cold shock to the patient on injection. Unfortunately, the light bulb is generally an uncontrolled heat source that may warm some carpules or cartridges to a temperature elevated above that desired, or that may not warm all carpules or cartridges to the desired temperature. Accordingly, such devices are not as effective as might be desired.

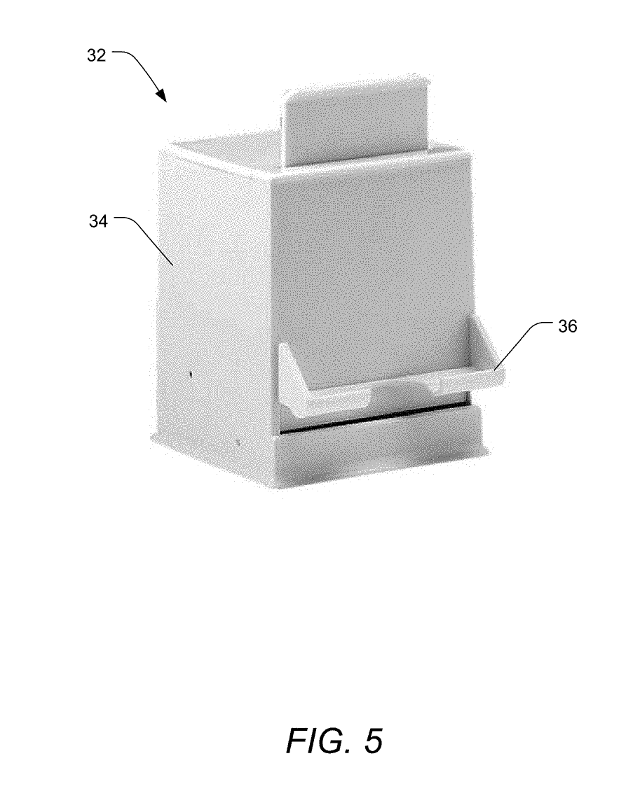

An anesthetic carpule or cartridge warmer and dispenser (warmer/dispenser 32) is illustrated in FIG. 5. The warmer/dispenser 32 includes a housing 34 that contains the carpules or cartridges. The warmer/dispenser 32 also includes an outlet 36 that dispenses individual carpules or cartridges upon activation of the warmer/dispenser 32 by a practitioner (e.g. a dental or medical professional). Internal to the housing, the carpules or cartridges may be disposed on one or more surfaces, such as on inclined planes that serve to cause the carpules or cartridges to automatically descend to the outlet 36. Where a traditional warmer or dispenser would have a single heat source such as a light bulb at the bottom of the warmer or dispenser, in the warmer/dispenser 32, one or more flexible sheets may be disposed along the internal surfaces of the housing, such as along the surfaces of the inclined planes, such that all carpules or cartridges are warmed simultaneously and evenly, and the ease of controlling the temperature of the flexible sheet ensures that the carpules or cartridges are heated essentially exactly to the desired temperature, without some being overheated and others being under-heated.

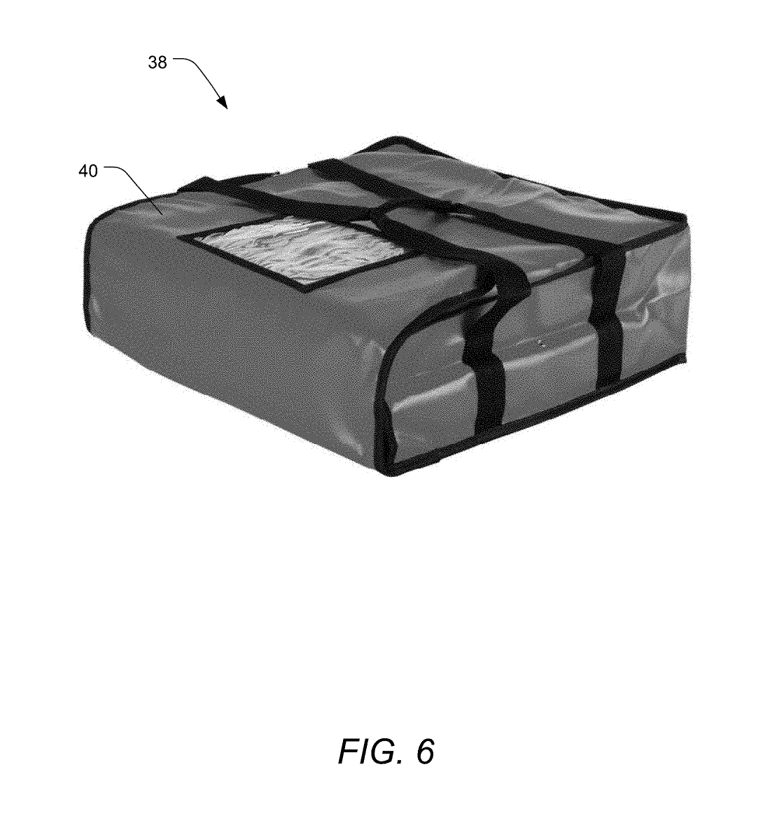

Another example of a device that may incorporate a flexible sheet heating system is a pizza warming box. A pizza warming box may be a box at a point of sale that maintains previously cooked pizzas at a desired temperature until they are sold, or it may be a portable pizza box, such as often used by pizza delivery personnel. A portable pizza delivery warming box 38 is shown in FIG. 6. The warming box 38 has an outer cover 40 that is generally insulating to keep the contents of the warming box 38 from losing too much heat. However, because the flexible sheet heating system can be incorporated into one or more sides, top, or bottom of the warming box, the pizzas contained therein can be evenly maintained closer to an ideal desired temperature. Because the flexible sheet heating system provides even and controllable heat, there is little concern of overheating of the pizzas as a whole (the system can just be turned down if necessary), and furthermore, there is no concern of variations in heating with respect to certain points within the warming box 38.

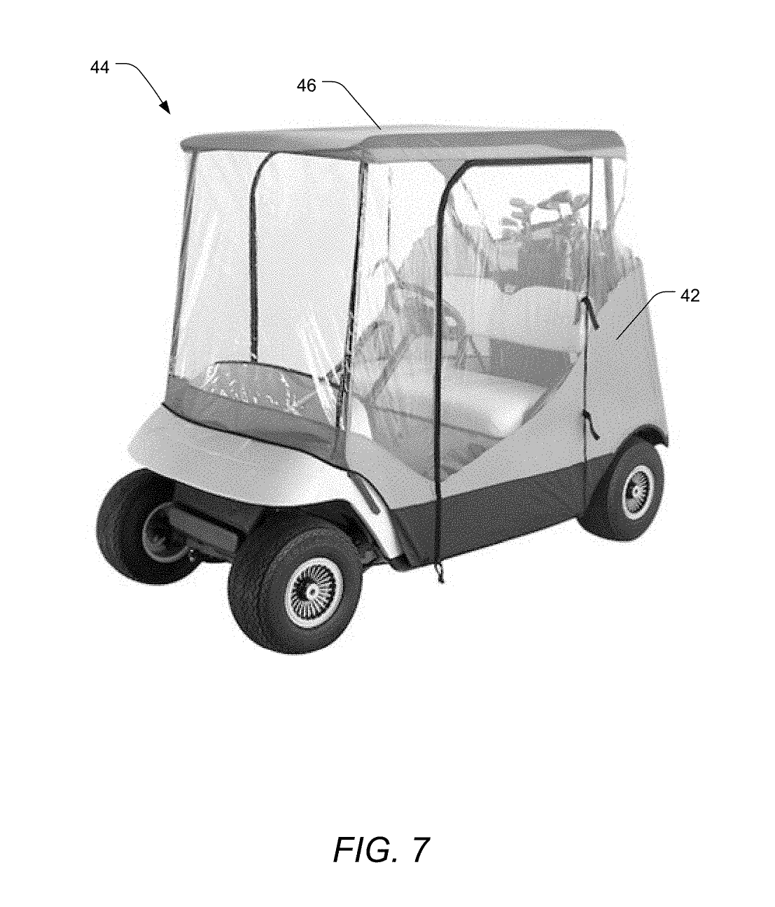

FIG. 7 illustrates another example in which a flexible sheet heating device may provide benefits to the user. FIG. 7 shows a golf cart cover 42 disposed on a golf cart 44. The golf cart cover 42 allows the interior of the golf cart 44 to be isolated from the external environment to some degree, mostly by reducing or eliminating unwanted wind gusts. Unfortunately, traditinoal golf cart covers are thin and provide only minimal protection from cold external temperatures. The golf cart cover 42 of FIG. 7, however, includes a flexible sheet heating system in the cover 42, such as along a top portion 46 thereof, or potentially along one or more of the sides of the golf cart cover 42. The flexible sheet heating system may operate from the golf cart battery and may provide significant even heating to the interior of the golf cart 44, such as through the golf cart top. Alternatively or additionally, the golf cart seat(s) may include one or more heating systems, such as in a seat cover as discussed above, thereby providing available heat to the golf cart occupant(s).

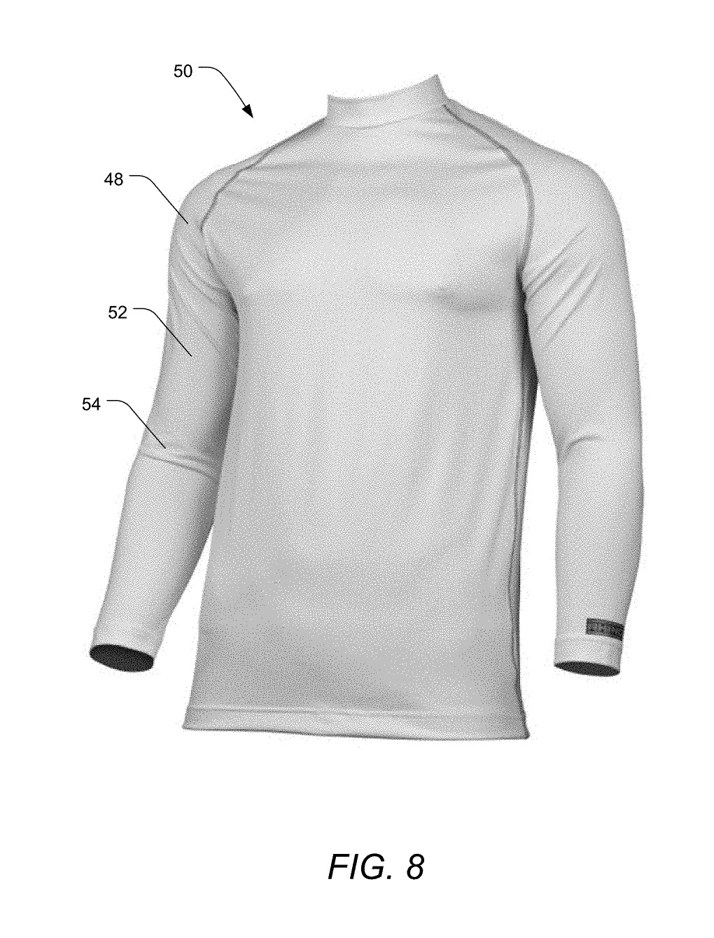

Another item in which a heating system as disclosed herein may be incorporated is an item of clothing, such as in shirts, compression shirts, pants, compression pants, compression sleeves, socks, compression socks, or other items of clothing. The heating system may provide steady, even heat to portions of the body of the wearer, either for purposes of heating the wearer generally, or for performance or therapeutic purposes. For example, the flexible sheet of the heating system may be disposed in a shoulder portion 48 of a compression shirt 50, as illustrated in FIG. 8. Accordingly the heating system may provide warmth at the shoulder of the wearer of the compression shirt 50. As another location alternative, the flexible sheet may be disposed at or near the biceps 52 of the compression shirt 50, or alternatively at the elbow or at some other joint or area of interest. Because the flexible sheet is flexible, it may serve within an item of clothing or within an item of compression clothing for a long period of time without breaking or otherwise failing due to body movement of wearer. While only one item of clothing is shown in FIG. 8, it should be understood that heating systems may be incorporated into essentially any item of clothing as desired.

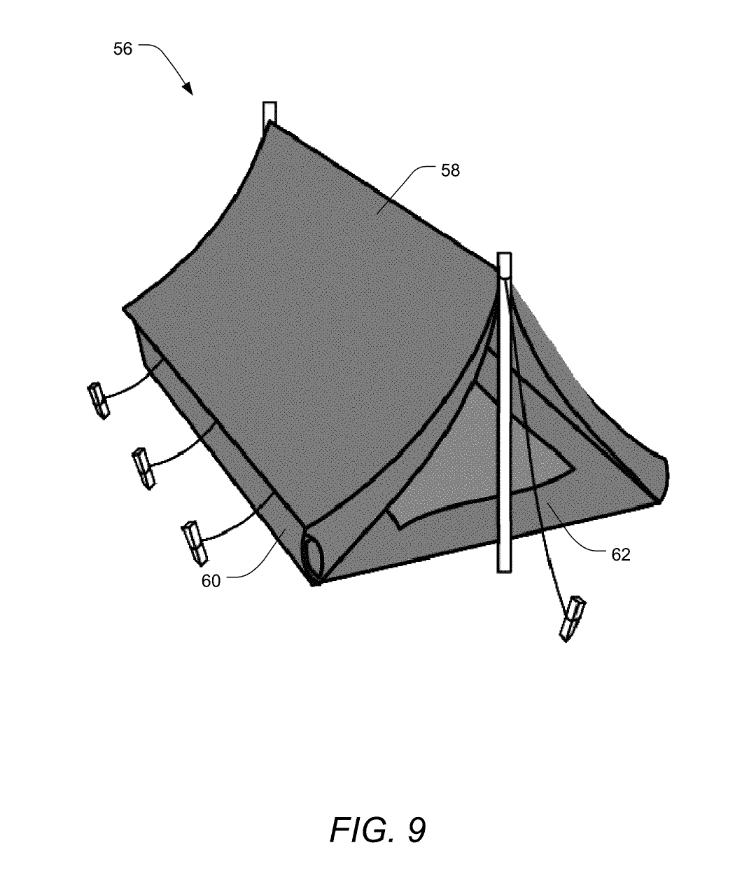

FIG. 9 illustrates another application for the heating system, namely as a tent heater. FIG. 9 shows a tent 56 in which the heating system has been or could be installed. The heating system may be disposed in any one or more of a variety of areas of the tent. In one example, the flexible sheet of the heating system may be disposed in a roof or ceiling 58 of the tent 56. In another example, the flexible sheet of the heating system may be disposed in one or more walls or sides 60 of the tent. In still a final example, the flexible sheet of the heating element may even be affixed to a bottom or floor 62 of the tent 56. Regardless of the final placement of the flexible sheet of the heating system, because the flexible sheet is flat and extremely thin, it may be placed in essentially any desired area of the tent 56 without taking up significant volume within the tent 56, unlike traditional stoves and the like that reduce the available volume within the tent 56 when they are used. The flexibility and durability of the flat sheet heating system ensures that the system will continue to operate even when the tent 56 is repeatedly disassembled and reassembled, or as tent occupants walk over the floor 62 of the tent 56.

In another embodiment, the flexible sheet may be disposed on a building roof, such as on top of a tar paper layer or similar layer, but below a shingle layer. Alternatively, the flexible sheet may be disposed below a metal roof layer. Even though one or more nails securing the shingles may pass through the flexible sheet, the heating capacity of the flexible sheet will not be interrupted or even significantly diminished. Accordingly, the flexible sheet may be used to heat the roof, such as to melt excessive snow or ice on the roof.

The present invention may be embodied in other specific forms without departing from its spirit or essential characteristics. The described embodiments are to be considered in all respects only as illustrative and not restrictive. The scope of the invention is, therefore, indicated by the appended claims, rather than by the foregoing description. All changes which come within the meaning and range of equivalency of the claims are to be embraced within their scope.

What is claimed and desired to be secured by Letters Patent is:

1. A heating system comprising:
a nano-layer;
a first polymer layer contacting and extending along a first side of the nano-layer;
a second polymer layer contacting and extending along a second side of the nano-layer; and
lead wires connected between the nano-layer and a heater control system operatively connected to a power supply;
wherein the nano-layer, the first polymer layer, and the second polymer layer form a flexible sheet.

2. The heating system of claim 1, wherein the flexible sheet is affixed to or incorporated in an item selected from the group consisting of:
a building roof;
a wall of a tent;
a ceiling or roof of a tent;
a floor of a tent;
an anesthetic carpule or cartridge warmer and dispenser;
a vehicle or golf cart cover;
a vehicle or golf cart seat cover;
a pizza box warmer;
an item of clothing; and
an item of compression clothing.

3. The heating system of claim 1, wherein the nano-layer has a thickness of approximately 0.01 mil.

4. The heating system of claim 1, wherein the first polymer layer and the second polymer layer have a thickness of between approximately 5 mil and approximately 20 mil.

5. The heating system of claim 1, wherein the first polymer layer and the second polymer layer comprise a material selected from the group consisting of:
polyethylene terephthalate (PET);
biaxially oriented polyethylene terephthalate (BoPET); and
polycyclohexylenedimethylene terephthalate (PCT).

6. The heating system of claim 1, wherein the nano-layer does not contain electrically conductive metal wires extending along the sheet except the lead wires proximate an edge of the sheet.

7. The heating system of claim 1, wherein the heater control system comprises a variable output having at least eight available output powers.

8. The heating system of claim 1, wherein the heater control system comprises a wireless communication link to permit control of the heating system by an application programming interface (API) operating on a mobile computing device.

9. The heating system of claim 8, wherein the mobile computing device comprises a device selected from the group consisting of:
a smartphone;
a tablet;
a laptop computer; and
a dedicated heating system control device.

10. A method for manufacturing a heating system for an item to be heated, the method comprising:
providing a first polymer layer;
spreading a graphene-containing mixture on the first polymer layer to form an electrothermal layer on the first polymer layer;
placing a second polymer layer on the electrothermal layer to form a flexible sheet having the electrothermal layer sandwiched between the first and second polymer layers;
cutting the flexible sheet to a shape adapted to provide heat to a desired area of an item to be heated;
affixing electrical leads to different areas of the electrothermal layer; and
affixing the flexible sheet to or incorporating the flexible sheet in a desired location of the item to be heated.

11. The method of claim 10, wherein the flexible sheet is affixed to or incorporated in an item selected from the group consisting of:
a wall of a tent;
a ceiling or roof of a tent;
a floor of a tent;
an anesthetic carpule or cartridge warmer and dispenser;
a vehicle or golf cart cover;
a vehicle or golf cart seat cover;
a pizza box warmer;
an item of clothing; and
an item of compression clothing.

12. The method as recited in claim 10, wherein the electrothermal layer has a thickness of approximately 0.01 mil.

13. The method as recited in claim 11, wherein the first polymer layer and the second polymer layer comprise a material selected from the group consisting of:
polyethylene terephthalate (PET);
biaxially oriented polyethylene terephthalate (BoPET); and
polycyclohexylenedimethylene terephthalate (PCT).

14. The method as recited in claim 11, wherein the flexible sheet is affixed to the item to be heated by a method selected from the group consisting of:
gluing;
bonding; and
stitching.

15. The method as recited in claim 11, further comprising operatively attaching the electrical leads to a heater control system.

16. The method as recited in claim 11, wherein the flexible sheet is cut into a first flexible sheet placed at a first desired area of the item to be heated, and a second flexible sheet is placed at a second desired area of the item to be heated.

17. A heating system comprising:
a nano-layer;
a first polymer layer contacting and extending along a first side of the nano-layer;
a second polymer layer contacting and extending along a second side of the nano-layer; and
lead wires connected between the nano-layer and a heater control system operatively connected to a power supply, the heater control system comprising a wireless communication link to permit control of the heating system by an application programming interface (API) operating on a mobile computing device;
wherein the nano-layer, the first polymer layer, and the second polymer layer form a flexible sheet that is attached to or incorporated in an item to be heated.

18. The heating system of claim 17, wherein the nano-layer has a thickness of approximately 0.01 mil.

19. The heating system of claim 17, wherein the mobile computing device comprises a device selected from the group consisting of:
a smartphone;
a tablet;
a laptop computer; and
a dedicated heating system control device.

20. The heating system of claim 17, wherein the first polymer layer and the second polymer layer comprise a material selected from the group consisting of:
polyethylene terephthalate (PET);
biaxially oriented polyethylene terephthalate (BoPET); and
polycyclohexylenedimethylene terephthalate (PCT).
